(19) United States
(12) Patent Application Publication
(10) Pub. No.: US 2022/0138070 A1
(43) Pub. Date: May 5, 2022

(54) USER INTERFACE AND HEALTH STATUS MONITORING FOR A MULTI SERVICE DOMAIN SYSTEM

(71) Applicant: NUTANIX, INC., San Jose, CA (US)

(72) Inventors: Sanika Nitin Mokashi, Mountain View, CA (US); Swetha Vallabhaneni, Newark, CA (US); Yiming Cao, San Jose, CA (US); Bryan Jeffrey Crowe, Santa Clara, CA (US)

(73) Assignee: NUTANIX, INC., San Jose, CA (US)

(21) Appl. No.: 17/302,189

(22) Filed: Apr. 27, 2021

Related U.S. Application Data
(60) Provisional application No. 63/108,033, filed on Oct. 30, 2020.

(51) Int. Cl. G06F 11/30; G06F 11/32; G06F 11/34; G06F 9/50

(52) U.S. Cl. CPC G06F 11/3006; G06F 11/324; G06F 9/5072; G06F 11/3051; G06F 9/5077; G06F 11/3409

(57) ABSTRACT

A platform as a service (PaaS) manager hosted on a central computing system runtime information for a first instance of a service at a first service domain and a second instance of the service at a second service domain separate from the first service domain. A first health status is generated for the first instance of the service and a second health status is generated for the second instance of the service based on runtime information. A central user interface displays at least the first health status and the second health status.

### CROSS-REFERENCE TO RELATED APPLICATIONS

This application claims priority to Provisional Application No. 63/108,033, filed on Oct. 30, 2020. The aforementioned application is incorporated herein by reference, in its entirety, for any purpose.

### BACKGROUND

Multi-cloud platform as a service systems (PaaS) may deploy various services across multiple service domains on one or more different types of computing platforms. Such services may be utilized by applications, such as Internet of things (IoT) applications developed and deployed using a multi-cloud PaaS system. While large scale systems with many types of service domains may be useful in reducing downtime, providing redundancy, and scaling services, managing multiple service domains may be challenging. Particularly, monitoring applications deployed across service domains and services utilized by such applications across multiple service domains may require monitoring performance of each individual service domain. Such fragmented monitoring may make problems, such as data leaks, improperly functioning services, offline service domains, and other issues difficult to identify and correct. Deploying instances of services across service domains may also require configuring and deploying services in each individual service domain, complicating application development and deployment.

### BRIEF DESCRIPTION OF THE DRAWINGS

FIG. 1 is a block diagram of a multi-cloud platform as a service system, in accordance with an embodiment of the present disclosure.

FIG. 2 is a block diagram of a Service Domain, in accordance with an embodiment of the present disclosure.

FIG. 3 is a block diagram of components of a computing node in accordance with an embodiment of the present disclosure.

FIG. 4A illustrates an exemplary user interface screenshot for monitoring services across service domains, in accordance with an embodiment of the present disclosure.

FIG. 4B illustrates an exemplary user interface screenshot for monitoring services across service domains, in accordance with an embodiment of the present disclosure.

FIG. 5 illustrates a flow chart for monitoring services across services domains, in accordance with an embodiment of the present disclosure.

FIG. 6A illustrates an exemplary user interface screenshot for creation of projects to allocate resources to a set of users, in accordance with an embodiment of the present disclosure.

FIG. 6B illustrates an exemplary user interface screenshot for creation of projects to allocate resources to a set of users, in accordance with an embodiment of the present disclosure.

FIG. 6C illustrates an exemplary user interface screenshot for creation of projects to allocate resources to a set of users, in accordance with an embodiment of the present disclosure.

FIG. 6D illustrates an exemplary user interface screenshot for creation of projects to allocate resources to a set of users, in accordance with an embodiment of the present disclosure.

FIG. 7A illustrates an exemplary user interface screenshot for adding services to a project, in accordance with an embodiment of the present disclosure.

FIG. 7B illustrates an exemplary user interface screenshot for adding services to a project, in accordance with an embodiment of the present disclosure.

FIG. 8 illustrates a flow chart for generating projects, in accordance with an embodiment of the present disclosure.

FIG. 9A illustrates an exemplary user interface screenshot for monitoring services and applications of a project across service domains, in accordance with an embodiment of the present disclosure.

FIG. 9B illustrates an exemplary user interface screenshot for monitoring services and applications of a project across service domains, in accordance with an embodiment of the present disclosure.

FIG. 9C illustrates an exemplary user interface screenshot for monitoring services and applications of a project across service domains, in accordance with an embodiment of the present disclosure.

FIG. 10 illustrates a flowchart for monitoring applications of a project across service domains, in accordance with an embodiment of the present disclosure.

### DETAILED DESCRIPTION

Examples described herein include a central computing system configured to monitor services, applications, and other software deployed at service domains hosted on a variety of computing platforms. The central computing system may provide a central user interface displaying information about operation of the various service domains, service instances, and/or application instances. Information displayed by the central user interface may include, in various examples, network connection of service domains, memory usage of applications and/or services at service domains, requests (e.g., I/O requests) to applications and/or services at service domains, and other health indicators for hardware or software of the service domain. The centralized user interface allows for monitoring of an entire system through a single interface, including statistics and information simplifying system monitoring, problem identification, and troubleshooting.

The central computing system may further provide simplified deployment of instances of services across service domains through the central user interface. Some examples described herein may provide “one touch” or simplified deployment of service instances across service domains, including simplified configuration of service instances across service domains. Such simplified deployment may allow for quicker development of new applications, as each individual instance of a service utilized by the application may be automatically configured, instead of being individually manually configured (e.g., by configuring settings in separate interfaces or application for each service domain included in a project). The central computing system may also, in various examples, provide the central user interface to update specific configuration parameters or settings for services. Configuration parameters or setting may be service-specific.

A service domain as used herein may describe any type of computing platform hosting or executing an instance of a service or an application dependent on or utilizing a service. For example a service domain may be a public or private cloud computing platform, a local computing cluster, a bare metal computing cluster, or other computer. Different service domains may, for example, run various operating systems, have a variety of different architectures (e.g., hyperconverged clusters, distributed computing systems, multi-tenant cloud environments), and/or be maintained, provided by, or administered by different vendors.

Applications may be generated and deployed across different types of service domains to provide robust applications with sufficient computing and memory resources and proximity to data or other information used by applications or services utilized by the applications. Generally, when an application is developed or generated, successful execution of the application may depend on availability of various supporting services, such as read/write data services (e.g., publish/subscribe services, search services, etc.), data pipeline services, machine learning (ML) inference services, container management services, other runtime or data. services, etc., or any combination thereof. The central computing system (e.g., a PaaS manager) may abstract deployment of supporting services, as some services may be platform-specific, as well as manage a lifecycle of service containers, virtual machines, upgrades to services, patches to the services, etc.

Projects, as used herein, may be groups including users or groups of users with access to services deployed at service domains. The users assigned to a project may develop, deploy, and/or maintain applications utilizing the services available to the users through the project. Users assigned to a project may be given different access to various services and applications and users may be added to projects at various stages. In some examples, the central user interface may provide for simplified creation and configuration of projects from the central computing system. Through project configuration, services may be configured and deployed at multiple service domains at one time. Some services, such as data services may be instantiated per-project, such that multiple instances of the same service are deployed at a service domain utilized in multiple projects.

Service instances and their bindings may be created using a service class. The service class may describe all available configuration options at time of service creation or update. A binding is created for project level scope services and a service instance is created for service domain level scope services. In some examples, the service instance may also be project level scope. In some examples, bindings may allow different applications to have different types of access to a common service (e.g., read-write, read-only, write-only, etc.). For a particular service, both a binding and a service instance can refer back to the service class. In some examples, only a service instance in the service domain context may accept configuration changes via the central computing system. In some examples, bindings may be useful when different applications in the same project require different access or when some applications are external, such that a service may have more than one different binding to a project with different configuration parameters.

In some examples, a user may provide information directed to an application to be deployed to a PaaS manager or central computing system and identify one or more target service domains, and the central computing system may deploy a respective application bundle for each of the one or more target service domains that includes the application and/or the additional supporting services. In some examples, the supporting services may already be hosted on the service domain, which may preclude inclusion of those services in the application bundle. The PaaS manager or central computing system may deploy the respective application bundle to the corresponding one of the one or more identified target service domains. The ability of the central computing system to abstract platform-specific details for creating and deploying a service domain and deploying an application bundle to run in a service domain may make deployment of applications to different service domains and across different computing platforms more efficient for a user. This may allow a user or customer to operate in a hybrid of various different computing platform types in a way that differences between the various computing platform types is transparent to an end user or customer. The ability to deploy applications across different computing platforms may allow for more flexible multi-cloud and/or multi-platform data integration for a customer.

Various embodiments of the present disclosure will be explained below in detail with reference to the accompanying drawings. The detailed description includes sufficient detail to enable those skilled in the art to practice the embodiments of the disclosure. Other embodiments may be utilized, and structural, logical and electrical changes may be made without departing from the scope of the present disclosure. The various embodiments disclosed herein are not necessarily mutually exclusive, as some disclosed embodiments can be combined with one or more other disclosed embodiments to form new embodiments.

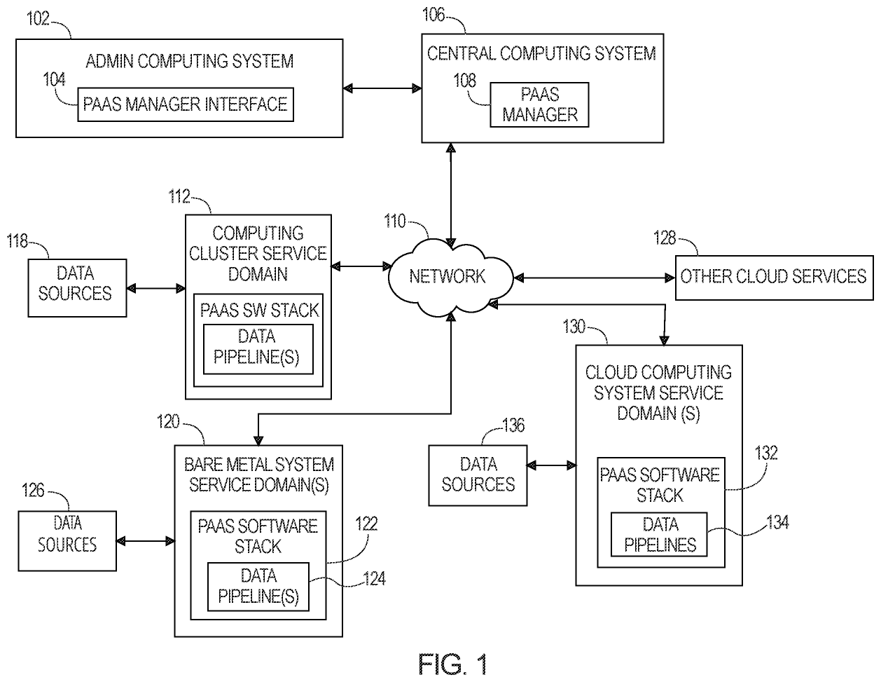

FIG. 1 is a block diagram of a multi-cloud platform as a service system 100, in accordance with an embodiment of the present disclosure. The system may include one or more of any of computing cluster service domains 112 coupled to respective data sources 118, bare metal system service domain(s) 120 coupled to respective data sources 126, and cloud computing system service domain(s) 130 coupled to respective data sources 136. The system may further include a central computing system 106 coupled to one or more of the computing cluster service domains 112, bare metal system service domain(s) 120, and/or cloud computing system service domain(s) 130 via a network 110 to manage communication within the system.

The network 110 may include any type of network capable of routing data transmissions from one network device (e.g., of the computing cluster service domains 112, the bare metal system service domain(s) 120, the central computing system 106, and/or the cloud computing system service domain(s) 130) to another. For example, the network 110 may include a local area network (LAN), wide area network (WAN), intranet, or a combination thereof. The network 110 may include a wired network, a wireless network, or a combination thereof.

Each of the computing cluster service domains 112 may be hosted on a respective computing cluster platform having multiple computing nodes (e.g., each with one or more processor units, volatile and/or non-volatile memory, communication or networking hardware, input/output devices, or any combination thereof) and may be configured to host a respective PaaS software stack 114. Each of the bare metal system service domain(s) 120 may be hosted on a respective bare metal computing platform (e.g., each with one or more processor units, volatile and/or non-volatile memory, communication or networking hardware, input/output devices, or any combination thereof) and may be configured to host a respective PaaS software stack 122. Each of the cloud computing system service domain(s) 130 may be hosted on a respective public or private cloud computing platform (e.g., each including one or more data centers with a plurality of computing nodes or servers having processor units, volatile and/or non-volatile memory, communication or networking hardware, input/output devices, or any combination thereof) and may be configured to host a respective PaaS software stack 132. “Computing platform” as used herein may refer to any one or more of a computing cluster platform, a bare metal system platform, or a cloud computing platform. “Service domain” as used herein may refer to any of the computing cluster service domains 112, the bare metal system service domain(s) 120, or the cloud computing system service domain(s) 130. The PaaS software stacks (e.g., any of the PaaS software stack 114, the PaaS software stack 122, and/or the PaaS software stack 132) may include platform-specific software configured to operate on the respective system. The software may include instructions that are stored on a computer readable medium (e.g., memory, disks, etc.) that are executable by one or more processor units (e.g., central processor units (CPUs), graphic processor units (GPUs), tensor processing units (TPUs), hardware accelerators, video processing units (VPUs), etc.) to perform functions, methods, etc., described herein.

The data sources 118, 126, and 136 may each include one or more devices or repositories configured to receive, store, provide, generate, etc., respective source data. The data sources may include input/output devices (e.g., sensors (e.g., electrical, temperature, matter flow, movement, position, biometric data, or any other type of sensor), cameras, transducers, any type of RF receiver, or any other type of device configured to receive and/or generate source data), enterprise or custom databases, a data lake (e.g., a large capacity data storage system that holds raw data) or any other source of data consumed, retrieved, stored, or generated by the service domains. The service domain construct may allow a customer to deploy applications to locations proximate relevant data, in some examples. In some examples, the service domain construct may allow a customer to deploy applications to computing platforms that have a particular computing resource (e.g., hardware or software configuration) and/or based on computing resource capacity.

In some examples, various components of the system may need access to other cloud services 128. To facilitate communication with the other cloud services 128, the data pipelines of the PaaS software stacks may be configured to provide interfaces between applications hosted on one or more of the service domains 112, 120, or 130 and the other cloud services 128 via the network 110. In some examples, the data pipeline(s) 116, 124, and/or 134 hosted on any of the PaaS software stacks 114, 122, and/or 132, respectively, may be configured to provide data from the other cloud services 128 to applications hosted on one or more of the service domains 112, 120, or 130 to aggregate, transform, store, analyze, etc., the data.

Each of the PaaS software stacks may include one or more applications, data pipelines, ML models, containers, data services, etc., or any combination thereof (e.g., applications). The applications may be configured to receive, process/transform, and output data from and to other applications. The applications may be configured to process respective received data based on respective algorithms or functions to provide transformed data. At least some of the applications may be dependent on availability of supporting services to execute, such as communication services, runtime services, read-write data services, ML inference services, container management services, etc., or any combination thereof.

The data pipelines 116, 124, and/or 134 may provide a conduit through which data can be passed (e.g., provided and/or received) between applications hosted in the PaaS software stack, as well as a conduit through which data can be passed among the different service domains or to the other cloud services 128 via the network 110. Generally, a data pipeline of the data pipelines 116, 124, and/or 134 may include an input component to receive data from another data pipeline, any data source, or other service domain or other cloud services 128 (via the network 110); and at least one transform component configured to manipulate the input data to provide the output data.

The data pipelines 116, 124, and/or 134 can be constructed using computing primitives and building blocks, such as VMs, containers, processes, or any combination thereof. In some examples, the data pipelines 116, 124, and/or 134 may be constructed using a group of containers (e.g., a pod) that each perform various functions within the data pipeline (e.g., subscriber, data processor, publisher, connectors that transform data for consumption by another container within the application or pod, etc.) to consume, transform, and produce messages or data. In some examples, the definition of stages of a constructed data pipeline application may be described using a user interface or REST API, with data ingestion and movement handled by connector components built into the data pipeline. Thus, data may be passed between containers of a data pipeline using API calls.

In some examples, the PaaS software stacks may further include respective ML inference services that are configured to load and execute respective ML model applications. Thus, the ML inference services may be configured to receive a request for an inference or prediction using a ML model, and to load a ML model application that includes the requested ML model into an inference engine. The inference engine may be configured to select a runtime based on a hardware configuration of the edge system, and execute the ML model on input data to provide inference or prediction data. The inference engine may be configured to optimize the ML model for execution based on a hardware configuration. The ML inference service may provide the benefits of CPU abstraction, built-in frameworks for ML model execution, decoupling application development from hardware deployment, etc. In some examples, the PaaS manager 108 may be configured to access data from the one or more data lakes, train a ML model using the transformed data, and generate an ML model application based on the trained ML model.

The one or more applications of the PaaS software stacks may be implemented using a containerized architecture that is managed via a container orchestrator. The container orchestration managed by a PaaS infrastructure and application lifecycle manager (PaaS manager 108) under the service domain construct may handle (e.g., using middleware) underlying details of the PaaS related to containerized management complexity, orchestration, security, and isolation, thereby making it easier for a customer or user to focus on managing the applications. The management may be scalable via categories. In some examples, the service domains may be configured to support multi-tenant implementations, such that data is kept securely isolated between tenants. The applications communicate using application programming interface (API) calls, in some examples. In some examples, the supporting services may also be implemented in the containerized architecture.

The PaaS manager 108 hosted on the central computing system 106 may be configured to centrally manage the PaaS infrastructure (e.g., including the service domains) and manage lifecycles of deployed applications. The central computing system 106 may include one or more computing nodes configured to host the PaaS manager 108. The central computing system 106 may include a cloud computing system and the PaaS manager 108 may be hosted in the cloud computing system and/or may be delivered/distributed using a software as a service (SaaS) model, in some examples. In some examples, the PaaS manager 108 may be distributed across a cluster of nodes of the central computing system 106.

In some examples, an administrative computing system 102 may be configured to host a PaaS manager interface 104. The PaaS manager interface 104 may be configured to facilitate user or customer communication with the PaaS manager 108 to control operation of the PaaS manager 108. The PaaS manager interface 104 may include a graphical user interface (GUI), APIs, command line tools, etc., that are each configured to facilitate interaction between a user and the PaaS manager 108. The PaaS manager interface 104 may provide an interface that allows a user to develop template applications for deployment of the service domains, identify on which service domains to deploy applications, move applications from one service domain to another, remove an application from a service domain, update an application, service domain, or PaaS software stack (e.g., add or remove available services, update deployed services, etc.).

In some examples, the PaaS manager 108 may be configured to manage, for each of the computing platforms, creation and deployment of service domains, creation and deployment of application bundles to the PaaS software stacks, etc. For example, the PaaS manager 108 may be configured to create and deploy service domains on one or more of the computing platforms. The computing platforms may include different hardware and software architectures that may be leveraged to create and deploy a service domain. Thus, the PaaS manager 108 may be configured to manage detailed steps associated with generating a service domain in response to a received request.

The PaaS manager 108 may also be configured to build and deploy different types of applications to one or more of the service domains. A user may elect to deploy an application to a type of platform based on various criteria, such as type of and/or availability of a service, proximity to source data, available computing resources (e.g., both type and available capacity), platform cost, etc., physical location of the platform, or any combination thereof.

When an application is generated, successful execution may depend on availability of various additional supporting services, such as a read/write data services (e.g., publish/subscribe service, search services, etc.), ML inference services, container management services, runtime services, etc., or any combination thereof. The PaaS manager 108 may abstract deployment of the additional supporting services, as some of these may be platform-specific. Thus, a user may provide information directed to an application to be deployed to the PaaS manager 108 and identify one or more target service domains, and the PaaS manager 108 may deploy the application to the target service domains. The target service domains provide services to be used by the application, and accordingly, the application need not include services provided by the service domain. Moreover, the application need not take platform-specific actions which may be typically required for starting those services. The PaaS manager 108 may deploy the respective application to the corresponding one of the one or more identified target service domains.

The ability of the PaaS manager 108 to abstract platform-specific details for creating and deploying a service domain and creating and deploying an application or application bundle to run in a service domain may make deployment of applications to different service domains more efficient for a user, as well as may provide a customer with a wider selections of platforms than would otherwise be considered. Thus, the service domain construct may allow a customer to focus on core concerns with an application, while shifting consideration of supporting services to the PaaS manager 108 and the service domains. The service domain construct may also make applications more “light weight” and modular for more efficient deployment to different service domains.

The PaaS manager 108 may also be configured to monitor services and applications deployed across service domains. For example, the PaaS manager 108 may monitor runtime information (e.g., memory use, I/O requests, processing use, network status, etc.) for each instance of a service deployed across multiple service domains. In some implementations, the PaaS manager 108 may also monitor runtime information for applications deployed across service domains as well as general status (e.g., functioning or not functioning) of individual service domains.

The PaaS manager interface 104 may provide a GUI interface for selecting a type of application to be deployed to one or more service domains, in accordance with an embodiment of the present disclosure. The PaaS manager interface 104 may also provide a GUI interface for monitoring various services deployed across various service domains in a single view. Accordingly, the GUI interface may allow a user to view all instances of all applications associated with the user, an entity, a project, an application, etc., to effectively monitor health of service domains and applications and services deployed at the service domains.

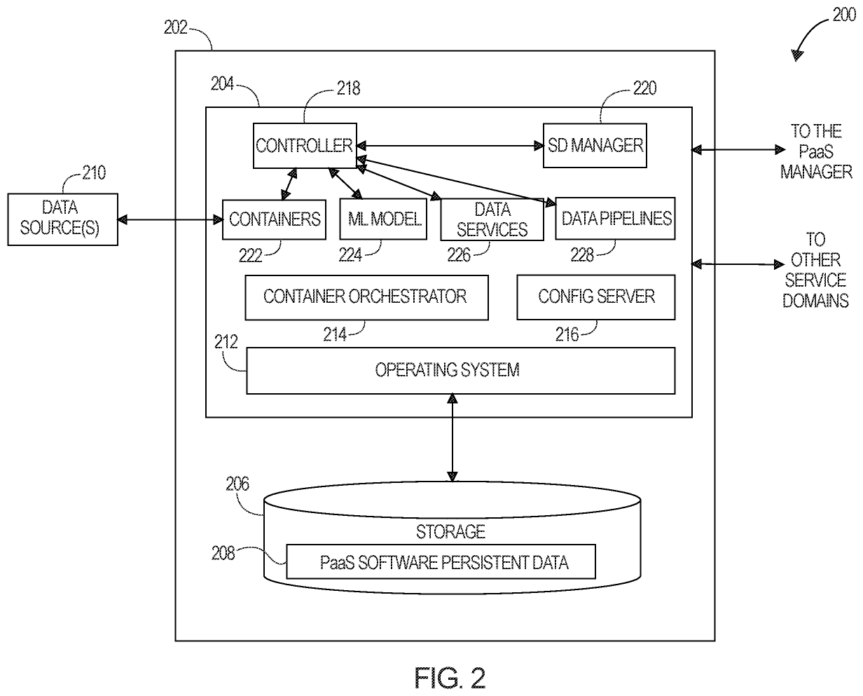

FIG. 2 is a block diagram of a computing platform 200 of an IoT system, in accordance with an embodiment of the present disclosure. The computing platform 200 may include a service domain 202 configured to host a PaaS software Stack 204 and storage 206. The computing platform 200 may include any of a computing cluster platform, a bare metal system platform, or a cloud computing platform. Any of the computing cluster service domains 112, the bare metal system service domain(s) 120, and/or the cloud computing system service domain(s) 130 of FIG. 1 may implement a respective version of the service domain 202. Any of the PaaS software stack 114, the PaaS software stack 122, and/or PaaS software stack 132 of FIG. 1 may implement some or all of the PaaS software Stack 204.

In some examples, the service domain 202 may be configured to host a respective PaaS software Stack 204. In some examples, the service domain 202 may include a VM hosted on the computing platform 200.

The storage 206 may be configured to store PaaS software persistent data 208, such as software images, binaries and libraries, metadata, etc., to be used by the service domain 202 to load and execute the PaaS software stack 114. In some examples, the PaaS software persistent data 208 includes instructions that when executed by a processor of the service domain 202, causes the service domain 202 to perform functions described herein. The storage may include local storage (solid state drives (SSDs), hard disk drives (HDDs), flash or other non-volatile memory, volatile memory, or any combination thereof), cloud storage, networked storage, or any combination thereof.

The PaaS software Stack 204 includes a bundle hosted on a physical layer of the service domain 202 to facilitate communication with one or more data source(s) 210, other service domains and/or computing platforms and/or a PaaS infrastructure and application lifecycle manager (e.g., the PaaS manager 108 of FIG. 1). The data source(s) 210 may include input/output devices (e.g., sensors (e.g., electrical, temperature, matter flow, movement, position, biometric data, or any other type of sensor), cameras, transducers, any type of RF receiver, or any other type of device configured to receive and/or generate source data), enterprise or custom databases, or any other source of data consumed, retrieved, stored, or generated by the service domains,.

The PaaS software stack 204 may host an underlying operating system 212 configured to interface the physical layer of the service domain 202. In some examples, a controller 218, a service domain manager 220, a container orchestrator 214, and a configuration server 216 may run on the operating system 212. In some examples, the PaaS software stack 204 may include a bare metal implementation that runs the operating system 212 directly on the physical layer. In other examples, the PaaS software stack 204 may include a virtualized implementation with a hypervisor running on the physical layer and the operating system 212 running on the hypervisor.

The container orchestrator 214 may be configured to manage a containerized architecture of one or more applications (e.g., containers 222, ML models 224, data services 226, and/or data pipelines 228). In some examples, the container orchestrator 262 may include Kubernetes® container orchestration software.

The service domain manager 220 may communicate with the PaaS manager to receive application bundles (e.g., including applications and supporting services) for installation (e.g., including the containers 222, the ML models 224, the data services 226, and/or the data pipelines 228), data source connectivity information, etc. In some examples, the service domain manager 220 may also be configured to provide configuration and status information to a centralized IoT manager, including status information associated with one or more of the data source(s) 210.

In response to information received from the PaaS manager, the service domain manager 220 may be configured to provide instructions to the controller 218 to manage the applications supported by the service domain 202, which may include causing installation or upgrading of one of the applications; removing one of the applications; starting or stopping new instances of the applications; allocating service domains to host the PaaS software stack 204; or any combination thereof. The PaaS software persistent data 208 may include application data that includes data specific to the respective application to facilitate execution, including supporting services.

As previously described, the applications may be implemented using a containerized architecture to receive source data from one or more of the data source(s) 210 (e.g., or from applications) and to provide respective transformed data at an output by applying a respective function or algorithm to the received source data. In some examples, the applications may include any user-specified or defined function or algorithm.

In some examples, the data pipelines 228 may be constructed using a group of containers (e.g., a pod) that each perform various functions within the data pipeline (e.g., subscriber, data processor, publisher, connectors that transform data for consumption by another container within the application or pod, etc.) In some examples, the definition of stages of a constructed data pipeline application may be described using a user interface or REST API, with data ingestion and movement handled by connector components built into the data pipeline. Thus, data may be passed between containers of a data pipeline 228 using API calls.

In operation, the PaaS software stack 204 hosted on the service domain 202 may control operation of the service domain 202 within an IoT system to facilitate communication with one or more data source(s) 210. The service domain manager 220 of the PaaS software stack 204 may communicate with the PaaS manager to receive allocation of a service domain to host the PaaS software stack 204 and receive application bundles for installation (e.g., including the containers 222, the ML models 224, the data services 226, and/or the data pipelines 228) on the PaaS software stack 204. In response to information received from the PaaS manager, the service domain manager 220 may be configured to provide instructions to the controller 218 to manage the application bundles, which may include causing installation or upgrading of one of the application bundles; removing one of the application bundles; starting or stopping new instances of the application bundles, allocating hardware resources to the PaaS software stack 204 as part of the service domain, storing data in and/or retrieving data from the PaaS software persistent data 208, or any combination thereof.

The applications may receive source data from one or more of the data source(s) 210 (e.g., or from other applications) and to provide respective transformed data at an output by applying a respective function or algorithm to the received source data. In some examples, the respective algorithms or functions may include machine learning (ML) or artificial intelligence (AI) algorithms. In some examples, the applications may cause the received and/or processed source data to be provided to other service domains via the configuration server 216. In some examples, the applications may be implemented using a containerized architecture deployed and managed by the container orchestrator 214. Thus, the container orchestrator 214 may deploy, start, stop, and manage communication with the applications within the PaaS software stack 204.

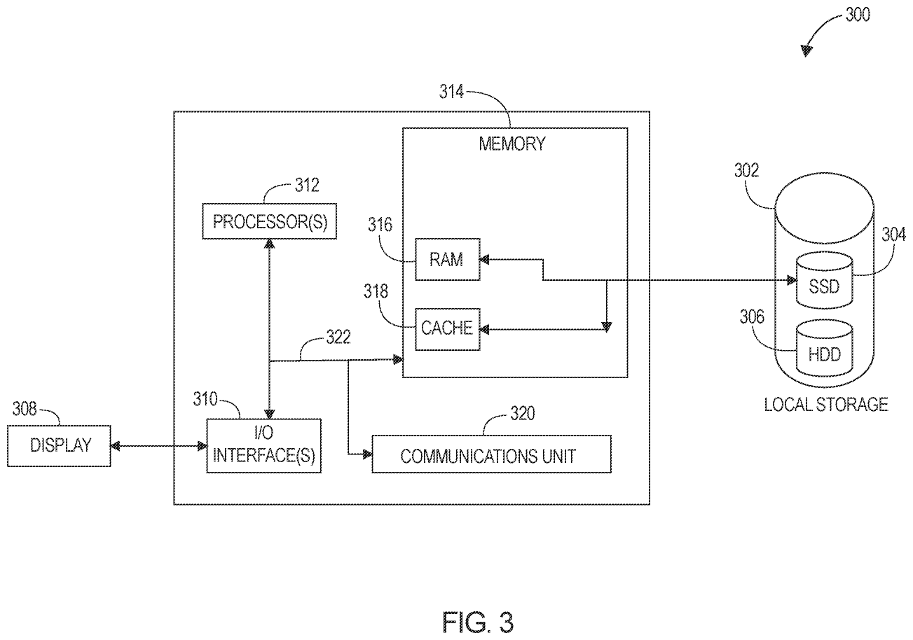

FIG. 3 is a block diagram of a computing node 300, in accordance with an embodiment of the present disclosure. The computing node 300 may be implemented as part of a cluster of computing nodes forming the computing cluster, the bare metal computing platform, or the cloud computing platform described with reference to FIG. 1 configured to host the described service domains.

The computing node 300 includes a communications fabric 322, which provides communication between one or more processor(s) 312, memory 314, local storage 302, communications unit 320, and I/o interface(s) 310. The communications fabric 322 can be implemented with any architecture designed for passing data and/or control information between processors (such as microprocessors, communications and network processors, etc.), system memory, peripheral devices, and any other hardware components within a system. For example, the communications fabric 322 can be implemented with one or more buses.

The memory 314 and the local storage 302 are computer-readable storage media. In this embodiment, the memory 314 includes random access memory RAM 316 and cache 318. In general, the memory 314 can include any suitable volatile or non-volatile computer-readable storage media. In an embodiment, the local storage 302 includes a SSD 304 and a HDD 306. The memory 314 may also store executable instructions. For example, where the central computing system 106 is implemented by a computing node 300, the memory 314 may store executable instructions for the PaaS manager 108. Where the computing node 300 is part of a computing cluster service domain 112, the memory 314 may store executable instructions for various layers of the PaaS software stack 204.

Various computer instructions, programs, files, images, etc., may be stored in local storage 302 for execution by one or more of the respective processor(s) 312 via one or more memories of memory 314. In some examples, local storage 302 includes a magnetic HDD 306. Alternatively, or in addition to a magnetic hard disk drive, local storage 302 can include the SSD 304, a semiconductor storage device, a read-only memory (ROM), an erasable programmable read-only memory (EPROM), a flash memory, or any other computer-readable storage media that is capable of storing program instructions or digital information.

The media used by local storage 302 may also be removable. For example, a removable hard drive may be used for local storage 302. Other examples include optical and magnetic disks, thumb drives, and smart cards that are inserted into a drive for transfer onto another computer-readable storage medium that is also part of local storage 302.

Communications unit 320, in some examples, provides for communications with other data processing systems or devices. In these examples, communications unit 320 includes one or more network interface cards. Communications unit 320 may provide communications through the use of either or both physical and wireless communications links.

I/O interface(s) 310 allow for input and output of data with other devices that may be connected to a computing node 300. For example, I/O interface(s) 310 may provide a connection to external devices such as a keyboard, a keypad, a touch screen, and/or some other suitable input device. External devices can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 302 via I/O interface(s) 310. I/O interface(s) 310 may also connect to a display 308.

Display 308 provides a mechanism to display data to a user a may be, for example, a computer monitor. In some examples, a GUI associated with the PaaS manager interface 104 may be presented on the display 308.

While not shown, in some examples, computing node(s), such as computing node 300 may be configured to execute a hypervisor, a controller virtual machine (VM) and one or more user VMs. The user VMs may be virtual machine instances executing on the computing node 300. The user VMs may share a virtualized pool of physical computing resources such as physical processors (e.g., hardware accelerators) and storage (e.g., local storage 112, cloud storage 124, and the like). The user VMs may each have their own operating system, such as Windows or Linux. Generally any number of user VMs may be implemented. User VMs may generally be provided to execute any number of applications which may be desired by a user.

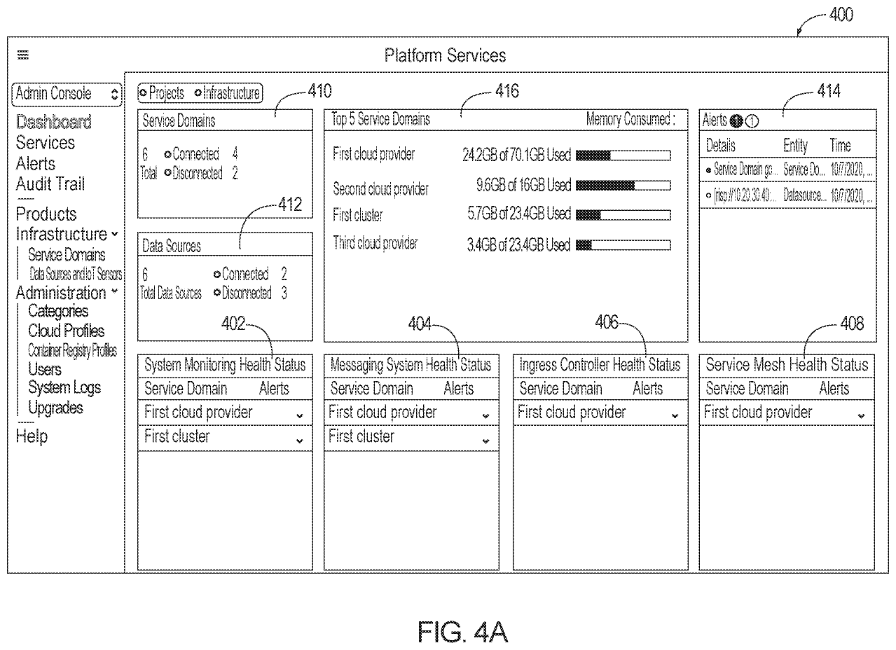

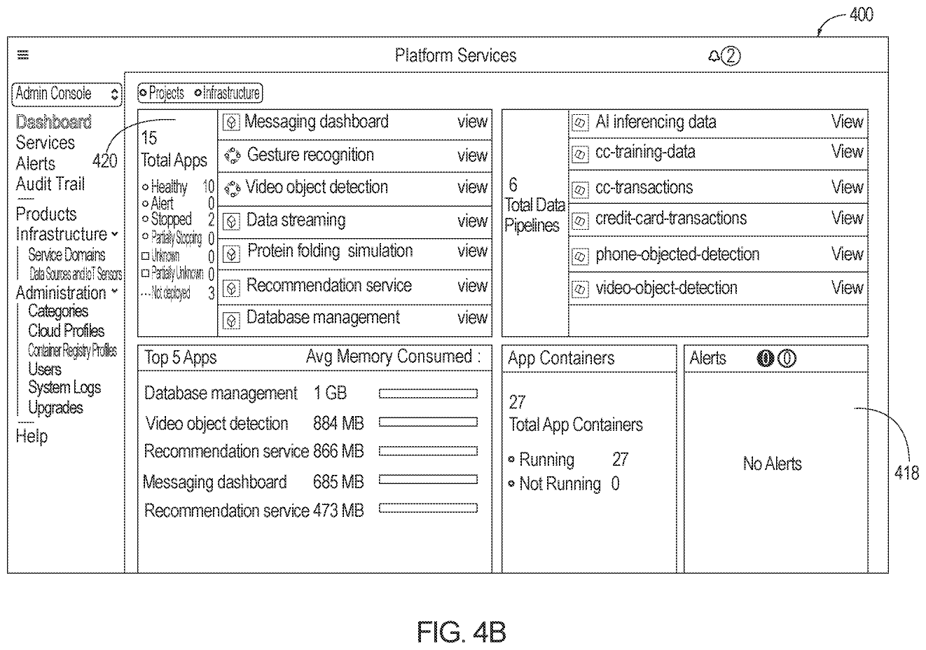

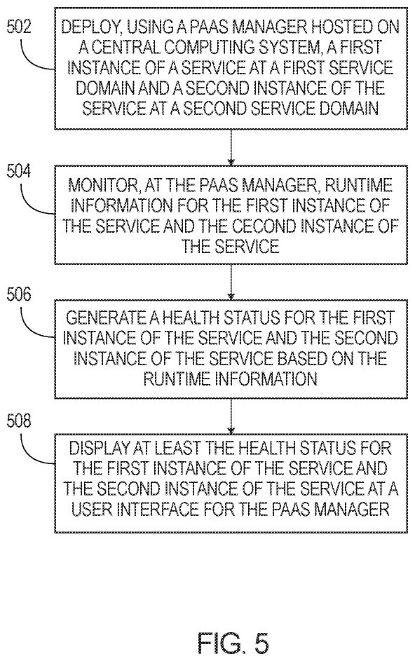

FIG. 5 illustrates a flow chart for monitoring services across services domains, in accordance with an embodiment of the present disclosure. Monitoring services across service domains can use, for example, the user interfaces shown in FIGS. 4A and 4B. At a block 502, a PaaS manager hosted on a central computing system (e.g., PaaS manager 108 hosted on central computing system 106) deploys a first instance of a service at a first service domain and a second instance of a service at a second service domain. For example, a particular service may be deployed at both a computing cluster service domain 112 and at one or more cloud computing system service domain(s) 130. In other implementations, services may be deployed additionally at one or more bare metal system service domain(s) 120, or at any combination of computing cluster service domains 112, bare metal system service domain(s) 120, and cloud computing system service domain(s) 130.

The PaaS manager 108 may deploy the services in any manner described with respect to FIGS. 1 and 2. At a block 504, the PaaS manager 108 monitors runtime information for the first instance of the service and the second instance of the service. In various implementations, the PaaS manager 108 may collect or gather runtime information from each of the service domains (e.g., via communication over a network 110). Runtime information may include, for example, memory use or CPU use for an instance of a service in a service domain, health status of applications using an instance of a service in a service domain (e.g., whether the application is executing as expected), connectivity of a service at a service domain, I/O requests made by applications to a service, alerts (e.g., when a service has encountered a runtime issue or configuration issue and is down at a particular service domain), workloads executed by the service, and other runtime statistics tracking performance of the service.

In some implementations, the PaaS manager 108 may provide a user interface or may otherwise allow a user to select specific runtime information to monitor per service, per project, or per service domain. A user may be, for example, an administrator or other person interacting with the PaaS manager 108 through another computer or an interface to the PaaS manager 108. In some examples, the user may be another application, computer process, or service interacting with the PaaS manager 108 through another computer or an interface to the PaaS manager 108.

Accordingly, a user may select relevant information or runtime information relevant to a particular application or project or goal. For example, where a service at a service domain is shared by several applications deployed at the service domain, the user may choose to monitor what portion of requests to the service come from each application utilizing the service. Such information may assist users in re-configuring a service for better performance, e.g., by deploying a new instance of the same service at the service domain for dedicated use by an application heavily utilizing the service. Further, the runtime information monitored may be dependent on which health status indicators the user selects. For example, where a user wishes to monitor network connectivity of each service domain, data usage of service domain resources may not be actively monitored, while downtime may be actively monitored consistent with a request from the user specifying monitoring of health status indicators for specified services.

At block 506, a health status is generated for the first instance of the service and the second instance of the service based on the runtime information. The health status may be generated by the central computing system 106 or by other compute resources (e.g., the admin computing system 102) in communication with the central computing system 106. A health status may, in some implementations, be a binary determination (e.g., the instance of the service is healthy or unhealthy). In these implementations, an unhealthy designation may mean that the service is not reachable over a network, the service has data sources that are disconnected, or that the service is otherwise not executing and performing as expected. In other implementations, the health status may include other intermediate rankings signifying that, for example, the service is within a threshold of using its allocated memory, computing power, connections, or is otherwise in danger of becoming overutilized or unhealthy. In some implementations, health status may include one or more factors contributing to the health status. For example, where a service is unhealthy, the health status may also include an indication that the service is offline because the service domain is disconnected.

At block 508, the PaaS manager 108 causes display of the health status for the first instance of the service and the second instance of the service at a user interface for the PaaS manager 108 (e.g., PaaS manager interface 104). For example, in one implementation, health status is displayed via the user interface 400 shown in FIG. 4A. User interface 400 provides an example of an administrator console (e.g., PaaS manager interface 104) showing health status information for services deployed in multiple service domains as well as additional information about the service domains.

The user interface 400 is one example of how health status of various services may be presented to a user. For example, the user interface 400 includes various panels displaying different types of information about the multi-cloud platform as a service system. The panels may be portions of a display screen, and may be displayed in a same window or in different windows. For example, a panel 402 shows health status of instances of a system monitoring service across two service domains by showing that both instances have no relevant alerts. In some implementations, additional information about each of the instances may be accessed through the user interface 400 (e.g., by selecting the name of the service domain in the panel 402 or selecting down arrows in line with the service domain names to reveal a drop down menu or drop down information. Panels 404, 406, and 408 provide similar displays for other services deployed in the multi-cloud platform as a service system. Other panels of the user interface 400 may provide additional information about hardware, software, applications, or other aspects of the system, For example, panel 410 shows the number of connected and disconnected service domains, panel 412 shows the number of connected and disconnected data sources, panel 414 shows details of alerts for the system, and panel 416 shows memory usage of service domains in the system. In various examples, panels shown in the user interface 400 may be presented individually or in various combinations to provide information about the system. In some examples, the central computing system may allow a user to select what types of information to present at the user interface 400.

FIG. 4B shows a user interface 400 that may be used to monitor the health and statistics of various applications running across multiple service domains, where the applications run on various services deployed at service domains of the multi-cloud platform as a service system. Health status indicators of services may, in some implementations, be presented with respect to applications. For example, a panel 418 of the user interface 400 shows alerts, which may include alerts for applications using services that have issued alerts. Similarly, panel 420 shows status indicators for applications, which may be based on health status of services and/or service domains.

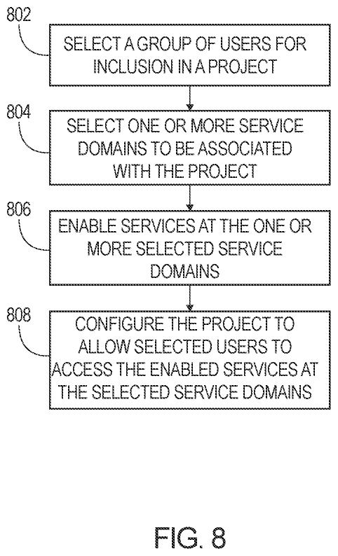

FIG. 8 illustrates a flow chart for generating projects, in accordance with an embodiment of the present disclosure. At block 802, a group of users are selected for inclusion in a project. For example, the group of users may be selected by an administrator or other user through the PaaS manager interface 104. In some examples, a user interface such as the user interface 602 may be generated by the PaaS manager 108 or the PaaS manager interface 104 to select users for inclusion in a project. In various implementations, projects may be used to allocate resources to groups of users. For example, a project may be used to group users who are developing an application using several services across service domains. Projects may also be used to group users (e.g., departments, job types, etc.) who require access to particular services. For example, the user interface 602 allows selection of users by name. In some implementations, a user interface may allow for selection of users based on, for example, job function, location, team assignments, or other attributes associated with users in addition to or instead of selecting individual users by name.

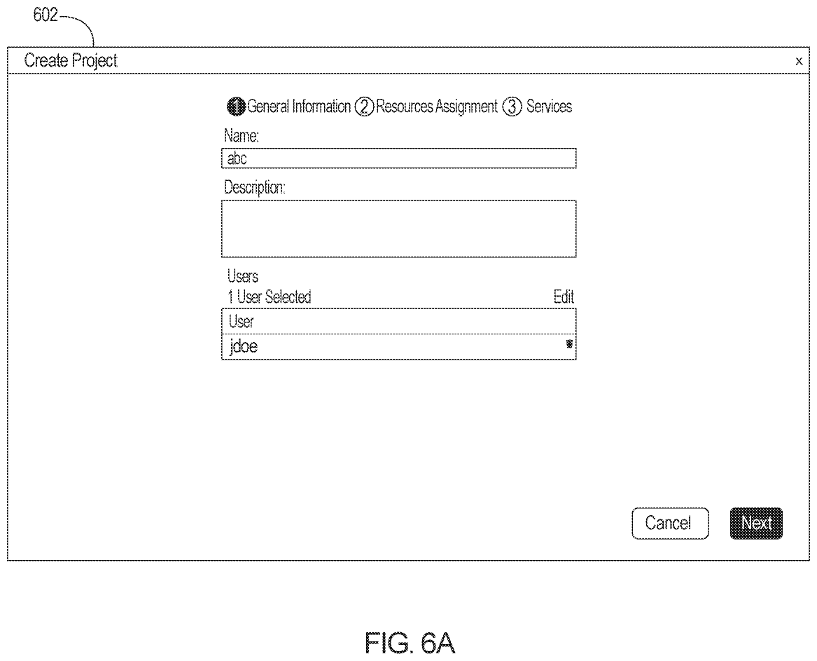

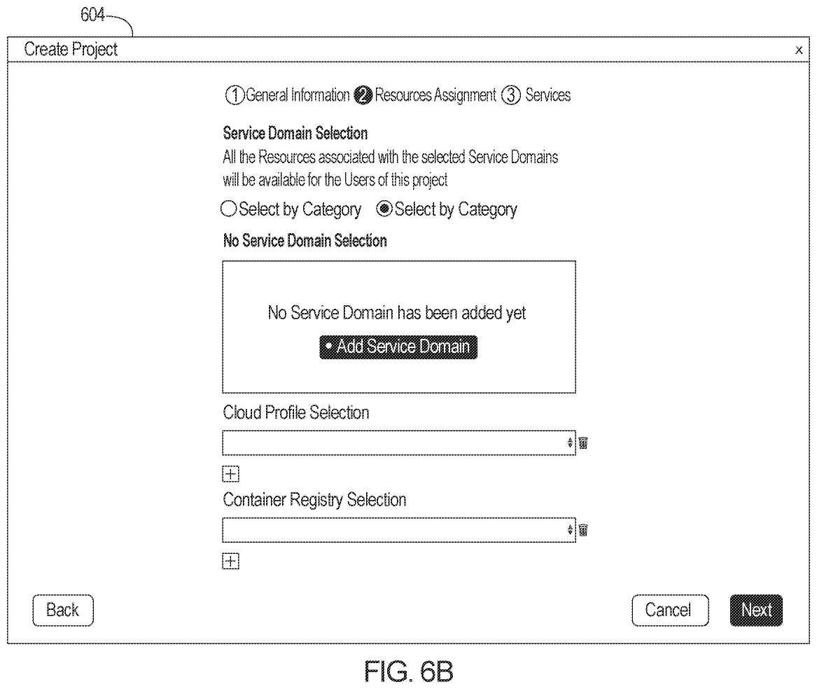

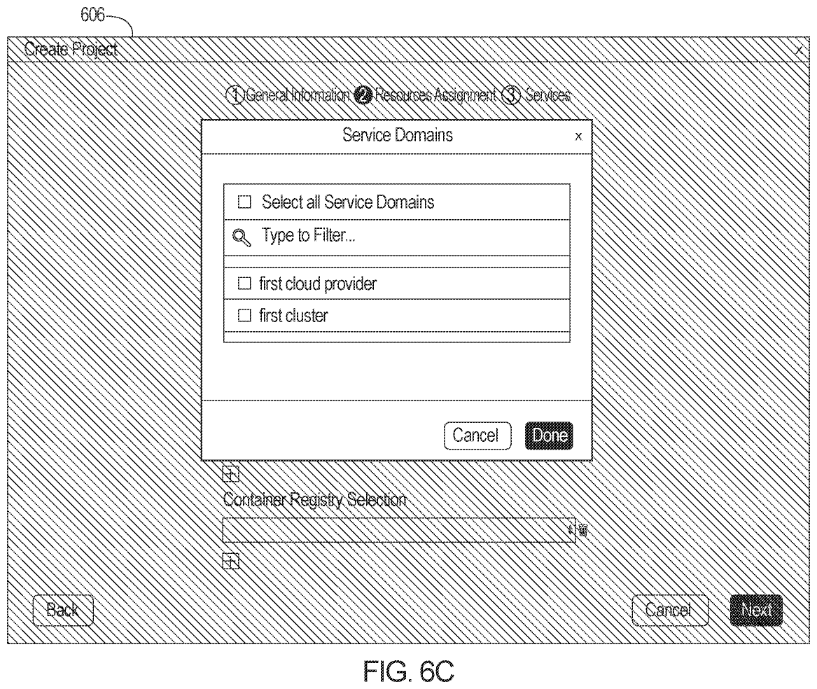

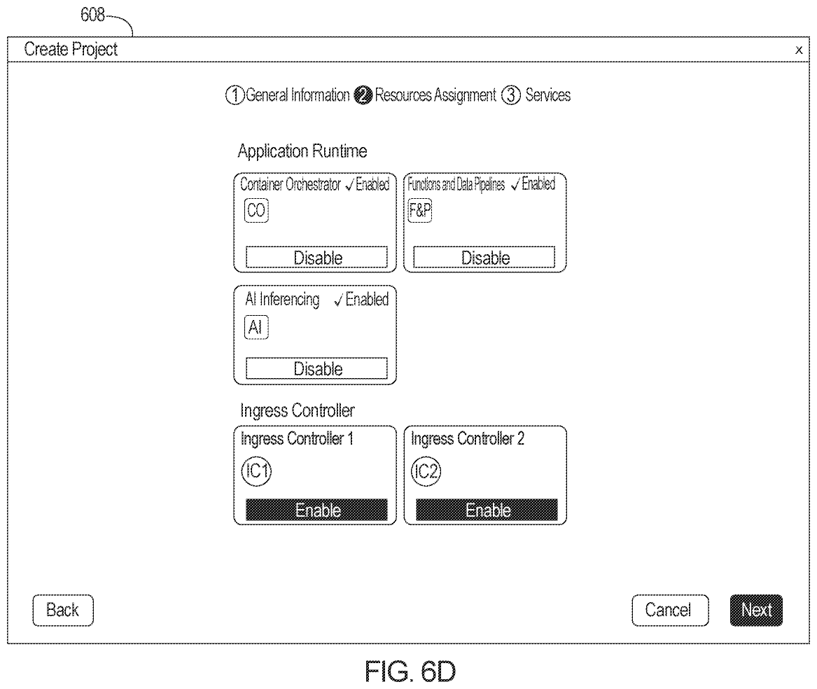

At block 804, one or more service domains are selected to be associated with the project. For example, the user interface 604 shown in FIG. 6B provides for service domain selection. Service domains may be selected for addition to a project based on, for example, the capacity of various service domains, the number of users in a project, the overall scale of the project (e.g., computing resources likely to be used by the project) and other factors. In some implementations, additional information may be associated with added service domains. For example, users may select, via a user interface (e.g., user interface 604) access to the service domains, particulars of cloud profiles, container policies, etc. Further, as shown in user interface 604, users may have the option of selecting individual service domains (e.g., from a list of all service domains available to an enterprise) or may select service domains by category. Category may include, for example, types of service domains (e.g., cloud based domains, on premises computing clusters, etc.), features of service domains (e.g., private or exclusive use domains, public or shared service domains, etc.), or other relevant characteristics. In some implementations, a secondary user interface, such as user interface 606 may provide a pop-up window, drop down menu, or other element for listing and selecting service domains for inclusion in a project.

At block 806, services are enabled at the one or more selected service domains. The PaaS manager 108 may enable services at the one or more selected service domains by, for example, updating the PaaS software stack at the selected service domains to include the selected services. In some examples, such updates may include causing the service domain to download and install a new PaaS software stack or installing binaries or software already stored locally at the selected service domains corresponding to the services. The PaaS manager 108 may also update access or privacy configurations (e.g., adding to users who can access the service at a service domain) to enable a service at a service domain. The PaaS manager 108 may also, in some examples, configure the services according to selections made by a user via the user interface. Once a service is enabled at a selected service domain, the service is installed and runs at the selected service domain.

Services may be enabled at selected service domains via a user interface (e.g., user interface 608 shown in FIG. 6D). In various implementations, services may be enabled across a subset of service domains added to a project or across all service domains added to a project. When enabling services, the user interface may provide options for configuration of specific instances of services. In some implementations, a user may select a service to enable at each service domain associated with a project. Such implementation may be “one click,” such that the user can enable the instances of the service at one time rather than enabling each instance of a service separately. For example, the user may select a service and service domains at which to enable the service. The PaaS manager 108 then handles the implementation of the service at the selected service domains by, for example, updating the PaaS software stack at the selected service domains and selecting settings for the service at each of the service domains.

At block 808, the project is configured to allow selected user to access the enabled services at the selected service domains.

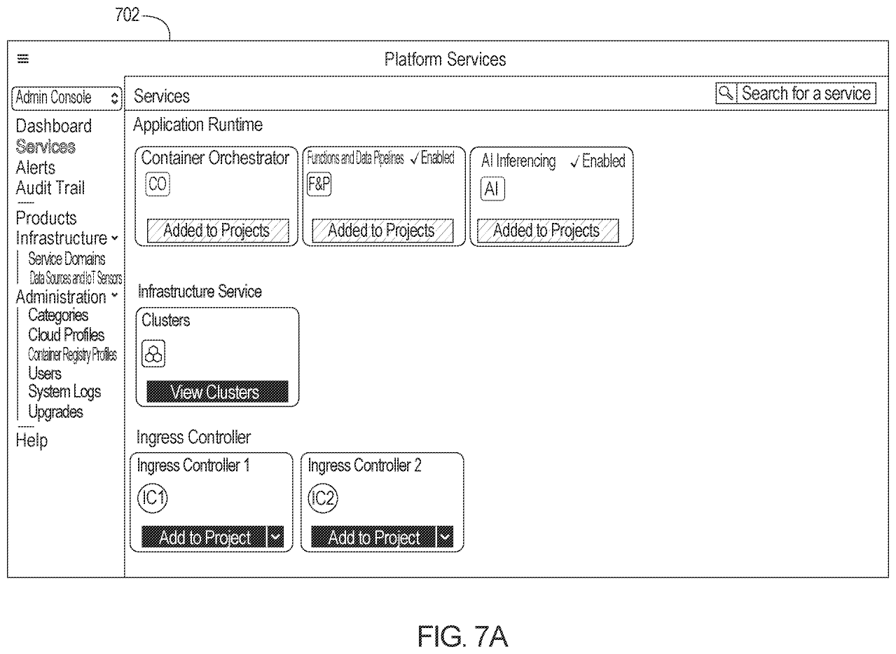

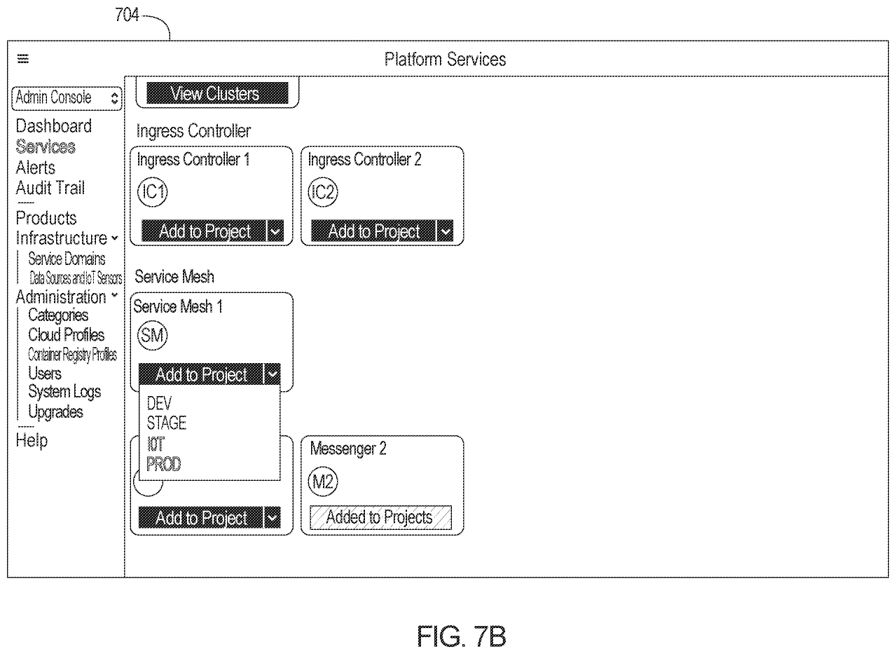

Once the services are enabled, additional user interfaces (e.g., user interfaces 702 and 704 shown in FIGS. 7A and 7B) may be used to monitor services enabled as part of a project as well as to view additional details about other available services that may be added to a project. In some implementations, a user (e.g., an administrative user) may select a project from a drop-down list, as shown in user interface 704 to enable a service at one or more projects. In these implementations, selecting a project from the drop-down menu may enable an instance of the service at each service domain included in the project.

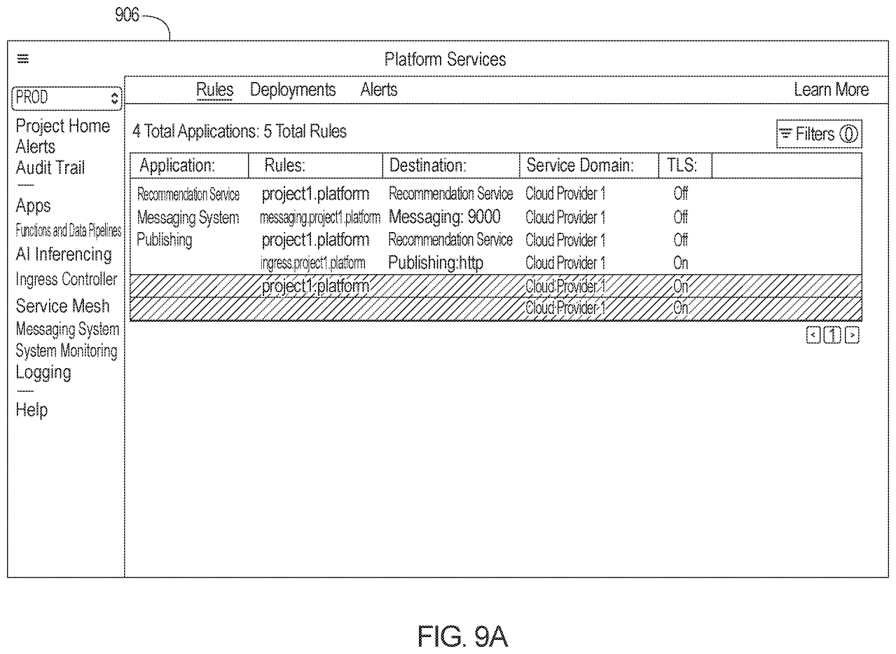

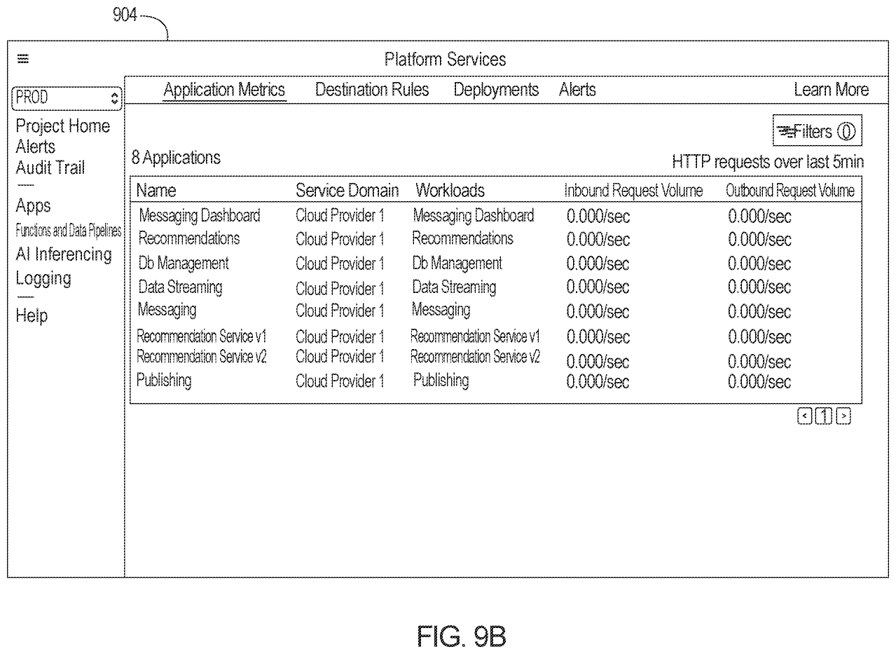

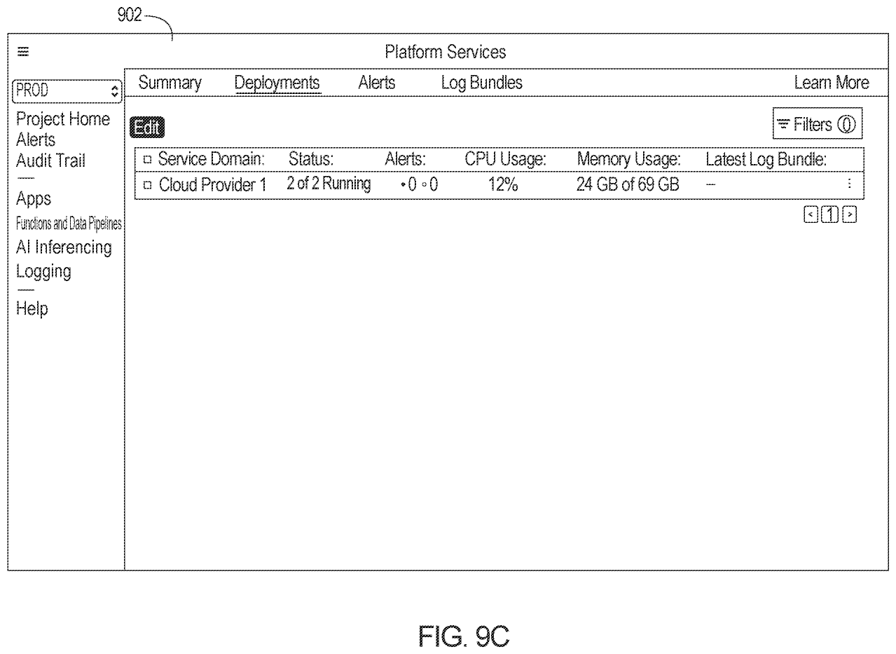

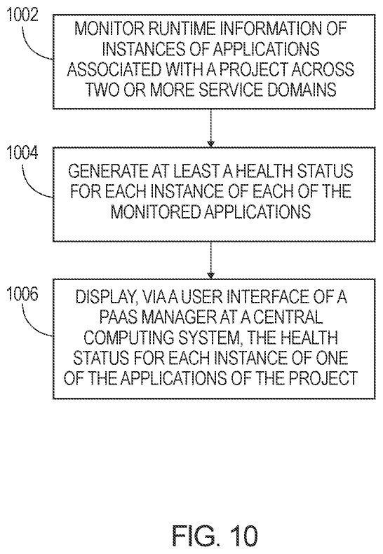

FIG. 10 illustrates a flow chart for monitoring applications of a project across service domains, in accordance with an embodiment of the disclosure. Applications may be user developed applications that rely on or use services deployed at one or more service domains and may he included as part of the PaaS software stack or run on top of the PaaS software stack at one or more service domains. At block 1002, runtime information is monitored for instances of applications associated with a project across two or more service domains. Such runtime information may include, for example, memory use, processing use, input/output requests, or other statistics or information associated with applications. The runtime information may be monitored by monitoring service domains associated with an application or services associated with the application. Accordingly, runtime information may include health status of service domains and/or services associated with an application. In some implementations, runtime data may be displayed via an administrator user interface (e.g., user interfaces 906 and 904 shown in FIG. 9A and FIG. 9B, respectively).

At block 1004, a health status is generated for each instance of each of the monitored applications. The health status may be generated by the central computing system 106, the admin computing system 102, or computing resources in communication with the central computing system 106 may generate the health status. A health status may, in some implementations, be a binary determination (e.g., the instance of an application is healthy or unhealthy). In these implementations, an unhealthy designation may mean that one or more service domains or services used to run the application are not reachable over a network, the application has data sources that are disconnected, or that the application is otherwise not executing and performing as expected. In other implementations, the health status may include other intermediate rankings signifying that, for example, the application is close to using its allocated memory, computing power, connections, or is otherwise in danger of becoming overutilized or unhealthy. In some implementations, health status may include one or more factors contributing to the health status. For example, where an application is unhealthy, the health status may also include an indication that a service used by the application is offline because the service domain is disconnected.

At block 1006, the health status for each instance of one of the applications of the project is displayed via a user interface of a PaaS manager at a central computing system. The health status may be displayed, for example, at a user interface (e.g., user interface 902 shown in FIG. 9C). In various implementations, health status may be displayed with different types of indicators such as icons, sliding scales, numeric values, or other graphical or textual means of conveying health status. The health statuses for each instance of one of the applications may be viewable in one interface, allowing an administrative user to monitor the application across service domains.

While certain components are shown in the figures and described throughout the specification, other additional, fewer, and/or alternative components may be included in the system or other computing systems. Such additional, fewer, and/or alternative components are contemplated to be within the scope of this disclosure.

What is claimed is:

1. A method comprising:
monitoring runtime information for a first instance of a service at a first service domain and a second instance of the service at a second service domain separate from the first service domain;
generating a first health status for the first instance of the service and a second health status for the second instance of the service based on the runtime information; and
displaying at least the first health status and the second health status at a central user interface.

2. The method of claim 1, wherein the first service domain hosts a first instance of an application utilizing the service and the second service domain hosts a second instance of the application.

3. The method of claim 1, further comprising deploying the first instance of the service at the first service domain and the second instance of the service at the second service domain.

4. The method of claim 1, wherein monitoring the runtime information comprises monitoring one or more of memory use, input/output (I/O) requests, processor use, and network status of the first instance of the service at the first service domain and the second instance of the service at the second service domain.

5. The method of claim 1 wherein the first service domain comprises a first computing platform and the second service domain comprises a second computing platform different from the first computing platform.

6. The method of claim 1, further comprising displaying, responsive to a determination that the health status of the first service domain or the health status of the second service domain is unhealthy, one or more options for improving the health status of the unhealthy service domain at the central user interface.

7. The method of claim 1, further comprising displaying a health status corresponding to each service supporting applications deployed at the first service domain and the second service domain.

8. The method of claim 1, further comprising displaying a health status corresponding to additional service domains included in a project including the first service domain and the second service domain.

9. One or more non-transitory computer readable media encoded with instructions which, when executed by one or more processors of a central computing system, cause the central computing system to:
monitor runtime information for a first instance of a service at a first service domain and a second instance of the service at a second service domain separate from the first service domain;
generate a first health status for the first instance of the service and a second health status for the second instance of the service based on the runtime information; and
display at least the first health status and the second health status at a central user interface.

10. The one or more non-transitory computer readable media of claim 9, wherein the first service domain hosts a first instance of an application utilizing the service and the second service domain hosts a second instance of the application.

11. The one or more non-transitory computer readable media of claim 9, wherein the instructions further cause the central computing system to deploy the first instance of the service at the first service domain and the second instance of the service at the second service domain.

12. The one or more non-transitory computer readable media of claim 9, wherein monitoring the runtime information comprises monitoring one or more of memory use, input/output (I/O) requests, processor use, and network status of the first instance of the service at the first service domain and the second instance of the service at the second service domain.

13. The one or more non-transitory computer readable media of claim 9, wherein the first service domain comprises a first computing platform and the second service domain comprises a second computing platform different from the first computing platform.

14. The one or more non-transitory computer readable media of claim 9, wherein the instructions further cause the central computing system to display, responsive to a determination that the health status of the first service domain or the health status of the second service domain in unhealthy, one or more options for improving the health status of the unhealthy service domain at the central user interface.

15. The one or more non-transitory computer readable media of claim 9, wherein the instructions further cause the central computing system to display a health status corresponding to each service supporting applications deployed at the first service domain and the second service domain.

16. The one or more non-transitory computer readable media of claim 9, wherein the instructions further cause the central computing system to display a health status corresponding to additional service domains included in a project including the first service domain and the second service domain.

17. One or more non-transitory computer readable media encoded with instructions which, when executed by one or more processors of a central computing system, cause the central computing system to:
provide a user interface configured for selection of one or more users for inclusion in a. project, selection of one or more service domains in the project, and selection of one or more services for inclusion in the project; and
enable instances of the selected one or more services at the one or more selected service domains such that the one or more selected users have access to the enabled service instances.

18. The one or more non-transitory computer readable media of claim 17, wherein the instructions further cause the central computing system to determine which selected services are previously enabled at the selected service domains, wherein enabling instances of the selected one or more services at the one or more selected service domains comprises creating instances of services not previously enabled at the selected service domains.

19. The one or more non-transitory computer readable media of claim 17, wherein enabling instances of the selected one or more services at the one or more selected service domains comprises configuring the selected services based on computing platforms of each of the selected service domains.

20. The one or more non-transitory computer readable media of claim 17, wherein the selected one or more service domains include one or more service domains comprising a first computing platform and one or more service domains comprising a second computing platform.

21. The one or more non-transitory computer readable media of claim 17, wherein the instructions further cause the central computing system to monitor runtime information for the one or more selected services at the one or more selected service domains.

22. The one or more non-transitory computer readable media of claim 17, wherein the instructions further cause the central computing system to display, via a central user interface, runtime statistics for the enabled services at the selected service domains.
